(19) United States
(12) Patent Application Publication
(10) Pub. No.: US 2025/0243099 A1
(43) Pub. Date: Jul. 31, 2025

(54) METHOD FOR OPTIMIZING SELECTIVE PRESSURE OF SURFACE WASTING IN A DENSIFIED ACTIVATED SLUDGE PROCESS

(71) Applicant: DENTRO-P, LLC, Yakima, WA (US)

(72) Inventor: Thomas E. Coleman, Yakima, WA (US)

(21) Appl. No.: 19/041,965

(22) Filed: Jan. 30, 2025

Related U.S. Application Data
(60) Provisional application No. 63/626,895, filed on Jan. 30, 2024.

(51) Int. Cl. C02F 11/02

(52) U.S. Cl. CPC C02F 11/02; C02F 2209/005

(57) ABSTRACT

A wastewater treatment method applicable to new or existing compartmented plug flow activated sludge process treatment tanks or alternatively sequencing batch reactors, which will improve the performance and efficiency in the treatment of municipal and industrial wastewater to remove phosphorus and nitrogen in optimizing surface wasting process steps in a densified activated sludge treatment process. The method optimizes operation of the wastewater treatment system by operating a surface wasting weir in a selector stage of the system's treatment tanks, and controlling a depth of flow and a volume of an activated sludge passing over the weir crest from the selector stage, followed by mixing the contents and controlling the intensity of mixing with pulsing operations, to establish a mixing regime and enhance development of a multiple of aerobic granular sludge microbial community assemblies in the activated sludge.

### TECHNICAL FIELD

The present disclosure relates to and is applicable to a wastewater treatment method applicable to new or existing compartmented “plug flow” activated sludge process treatment tanks, and will improve the performance and efficiency in the treatment of municipal and industrial wastewater to remove phosphorus and nitrogen in optimizing surface wasting process steps in a densified activated sludge treatment process. The present invention may also be similarly applied to a sequencing batch reactor activated sludge activated sludge treatment processes with similar benefits as described herein.

### BACKGROUND OF THE INVENTION

The activated sludge treatment process has been used for many years for the removal of “biochemical oxygen demand” (BOD) from municipal wastewaters. This conventional process consists of an aeration basin containing a suspension of microorganisms referred to as mixed liquor. Wastewater is fed to the aeration basin and oxygen is utilized by the biomass to sorb, assimilate, and metabolize the BOD available in the wastewater. From the aeration basin, mixed liquor flows to a clarifier where the biomass settles and treated wastewater overflows. Most of the settled biomass is returned to the aeration basin. A smaller portion is wasted in order to maintain a relatively constant quantity of biomass in the system. The activated sludge process has been extensively described in prior technical literature and textbooks, and is well known to those skilled in this field.

Municipal and industrial wastewater treatment systems which are able to develop “aerobic granular sludge” (AGS) represent an emerging technology which offers significant advantages over conventional flocculant activated sludge treatment systems. AGS has better settling properties providing for more effective biomass-water separation and higher biomass concentrations in the reactor tanks typically employed in an “enhanced biological phosphorus removal” (EBPR) treatment processes. Each AGS granule can be considered as a self-contained treatment system that can achieve simultaneous nitrification, denitrification and phosphate removal.

A simplified process schematic of a conventional and generic EBPR treatment process is shown in prior art FIG. 1, as included herewith. The typical EBPR 20 process employed in an “activated sludge wastewater treatment system” (ASWTs) 21 or waste water treatment plant that incorporates an Anaerobic Zone 22 followed by an Anoxic Zone 23, and then an Aerobic Zone 24 that also can be referred to as an Oxic Zone. The Anoxic Zone receives a wastewater influent 25, which is typically a municipal waste stream. A suspension of bacteria and other microorganisms referred to as a mixed liquor 30 is maintained in an aeration basin 32, for conversion into an activated sludge 33. An aeration basin effluent 34 flows to a clarifier 35, where the mixed liquor settles and is returned to the aeration basin, where the clarified effluent 36 as a treated wastewater overflows the clarifier for optional additional treatment, disinfection, and then disposal. A small fraction of a settled mixed liquor 38 within the clarifier is wasted as a “waste activated sludge” (WAS) stream 40 from the system, typically to a digestion process in order to maintain the desired concentration of mixed liquor in the aeration basin.

ASWTs offer cost-effective wastewater treatment for small municipalities, and thousands of such plants exist in the United States and around the world today. The typical ASWTs employing the EPBR 20 process is characterized by an aeration basin in which aeration and mixing of the biological solids or “mixed liquor suspended solids” (MLSS) is maintained. Various types of mechanical equipment have been used to provide mixing and aeration. Commonly used aeration and mixing systems include surface aerators, and diffused aeration grids that are sometimes coupled with mechanical mixers.

In order to design and operate an activated sludge system in which the mixed liquor 30 is predominantly composed of aerobic granules it is necessary to create and maintain conditions which favor the formation of granules and to apply a physical selection process which preferentially retains the optimally sized granules within the system. However, it is also important that the granule size distribution falls predominantly within an optimal size range typically from 200 to 400 microns in diameter as suggested by current evidence. Granules that are too small will lack the ability to simultaneously nitrify and denitrify and remove phosphate. Granules that are too large have diffusion limitations and much of the granule will be composed of inactive biomass within its interior portions. While it may not be possible to precisely define an optimal size, it is clear that having the ability to control the size of granule development is very important.

An effective method to control granule size is needed, to provide sufficient shear inducing turbulence at one or more points in the activated sludge process. An alternate method would be to preferentially waste granules which exceed a certain optimal size range.

Biological nitrogen removal can be achieved in ASWTs 21 by controlling the aeration conditions within the reactor tanks. Human activities can accelerate the rate at that nutrients enter ecosystems. It is increasingly common for regulatory agencies to impose limits on phosphorus (P) as well as nitrogen (N) on discharges from wastewater treatment plants. The basic engineering principles for the design of P and N removal treatment facilities have been well established and have been implemented in various configurations including, the “Modified Bardenpho Process”, the “UCT Process”, the “A2O Process”, and others as are known to those skilled in wastewater treatment processing.

The Modified Bardenpho Process configuration of the Basic Activated sludge process is shown in FIG. 1. This process typically includes one or more anaerobic zones, followed by one or more anoxic zones and one or more aerobic zones. Process designs based upon the Modified Bardenpho Process typically include one or more anaerobic zones to promote “enhanced biological phosphorus removal” (EBPR), and also provides strong selective pressure against filamentous bacteria growth while at the same time promoting the growth of a denser, better settling biomass, a portion of which may include AGS. In these situations, the present invention will meet the need to facilitate efficient and effective surface wasting, and will further help select against the growth of filamentous bacteria, but more importantly will help select for the denser constituents of the mixed liquor biomass, including aerobic granular sludge.

A primary function of diffused aeration systems in activated sludge aeration basins is the transfer of oxygen to the mixed liquor. In the latter stages of the aeration basins where surface wasting systems are typically applied, the oxygen demand is low and the diffused air flux rates are correspondingly low when controlled to maintain the desire dissolved oxygen concentration in the basin. This existing EPBR 20 system generally works well when the primary objectives of surface wasting are to limit filament growth and foam control. It may also work adequately when a primary objective is to preferentially retain aerobic granules during the start-up phase of a continuous flow activated sludge AGS system. However, as the AGS microbial community becomes more fully developed as indicated by particle size distribution analyses and the ability to fully achieve simultaneous nitrification and denitrification in the first aerated zone, then the ability to provide sufficient shear to maintain granule sizes within the optimal range becomes very important as does the ability to waste aerobic granules more uniformly over the entire range of granule sizes in the system.

If diffused aeration alone were to be used to provide the necessary shear forces and the degree of mixing necessary to provide uniform wasting over a surface wasting weir, the air flow rate would greatly exceed the rate required to maintain the necessary dissolved oxygen levels. This results in a waste of energy and process efficiency, with other potentially adverse impacts to the process such as the return of some oxygen to the anaerobic selector zones in the RAS.

A physical process flow configuration, which is possible once a sufficient fraction of the mixed liquor is composed of aerobic granules, is shown in FIG. 3. A known objective for an AGS system at steady state is to operate with one or more anaerobic stages in series, followed by aerobic stages where simultaneous nitrification and denitrification occurs within aerobic granular sludge microbial communities.

Surface wasting of activated sludge from an aerated zone equipped with a fine bubble diffused aeration system was originally developed as a means of controlling filamentous bacteria and foaming conditions in flocculant activated sludge systems. The fine bubbles introduced by the aeration system tend to lift the filamentous bacteria and foam to the surface of the reactor where they can be removed or wasted from the system by drawing a thin layer of liquid from the surface over a weir, typically at a depth of approximately 1 to 2 cm over the weir. Surface wasting in this manner has long been used to effectively control filamentous sludge bulking and foaming in flocculant activated sludge systems.

Conversely, when such a surface wasting system is applied to an EBPR process which can support the development of some aerobic granules within the microbial population of the activated sludge, it can become a selective process which tends to retain more of the aerobic granules in the system relative to the flocculant bacterial fraction as the mixer liquor is withdrawn from the surface. While the difference in the relative abundance of granules between the upper and lower portions of the reactor water column may be small, over time this surface wasting method becomes an important physical selection process which favors the development of aerobic granular sludge.

Similarly, where surface wasting is carried out in the final aerobic zone of an EBPR system at low diffused aeration flux rates, there will be selective pressure favoring the retention of larger granules relative to smaller granules since the larger granules will be relatively more abundant in the lower portions of the reactor water column and less abundant in the upper portions of the water column. These physical selection processes become very important in the development of a continuous flow activated sludge system which consists predominantly of aerobic granular sludge microbial communities. This is particularly true during the start-up phase where the system must go through a transition from a flocculent EBPR activated sludge process to an AGS process.

The present invention will allow engineers and plant operators to better exploit the microbial communities which carry out EBPR and “nitrification/denitrification” (NdN) to protect the environment and to significantly reduce the amount of energy and chemicals consumed in removing nutrients from wastewater discharges. The metabolic pathways used by the “polyphosphate accumulating organisms” (PAOs), which play an essential role in EBPR as shown schematically in FIG. 2. The basic engineering principles for the design of P and N removal treatment facilities have been well established and have been implemented in various known configurations including, the “Modified Bardenpho Process”, the “UCT Process”, and as the “A2O Process”.

The prior art Modified Bardenpho Process EBPR configuration is shown schematically in FIG. 3, herein. All of these prior processes include one or more anaerobic zones, followed by one or more anoxic zones and one or more aerobic zones. The only treatment plant systems that would not include an anoxic zone would be those that are not required to, and do not nitrify. For all others, it is imperative that any return activated sludge or mixed liquor be denitrified before being returned to the anaerobic zone.

Human activities can accelerate the rate at which nutrients enter ecosystems. Phosphorus (P) is often the limiting nutrient in cases of eutrophication in lakes and rivers subjected to run off and/or point source pollution from wastewater treatment plants. At the same time, phosphate rock from which P fertilizers are produced is a non-renewable resource which is being rapidly depleted. More effective process control systems will help to promote the maximum use of EBPR where chemical precipitation for P removal might otherwise be used. This is also important because P can be recovered as a by-product of EBPR systems for beneficial use as fertilizer, while P from chemical precipitates removed using metal salts cannot be effectively recovered.

It is becoming increasingly common for regulatory agencies to impose limits on phosphorus as well as nitrogen on discharges from wastewater treatment plants. The biological removal of both nutrients is more complex since the efficiency of both processes is dependent, in part, on the available organic carbon (C) substrate in the influent wastewater or from an external source, when necessary.

Municipal and industrial wastewater treatment systems which are able to develop AGS as a by-product represent an emerging technology which offers significant advantages over conventional flocculant activated sludge treatment systems. AGS has better settling properties providing for more effective biomass-water separation and higher biomass concentrations in the reactor tanks. Each AGS granule is a self-contained treatment system which can achieve simultaneous nitrification, denitrification and phosphate removal.

In this way, AGS systems reduce reactor sizes and space requirements, lower energy costs, and reduce capital costs. To date, the majority of the full-scale WWTP installations which have been specifically designed to produce AGS microbiology utilize “sequencing batch reactor” (SBR) technology.

Worldwide, the great majority of activated sludge wastewater treatment plants are continuous flow systems which have separate aeration tanks and clarifier tanks. The clarifiers, or sedimentation tanks, provide for separation of the microbial biomass from the treated liquid to be discharged and for return of the settling biomass back to the aeration basins as a “return activated sludge” (RAS). Also, a portion of the microbial biomass is continuously removed from the system as a “waste activated sludge” (WAS) in order to maintain steady state conditions.

While not originally designed or expected to produce AGS as a significant portion of the activated sludge biomass, many EBPR facilities have been shown to support the growth of AGS to varying degrees when microscopic and particle size analyses have been performed. The factors which appear to enhance AGS development in EBPR designs include multistage anaerobic and/anoxic selector zones ahead of the aerated zones and physical selection process elements including surface wasting of WAS from an aerated zone, and hydrocyclone separators on the RAS or another internal recycle flow stream.

### SUMMARY OF THE INVENTION

The present invention will achieve the improved efficiencies by increasing the selective pressures on the microbial communities that make up the activated sludge used for biological nutrient removal, to help develop and maintain “aerobic granular sludge” (AGS) to increase the relative portion of AGS in the microbial population making up the activated sludge mixed liquor. In addition, the optimal AGS particle size distribution will be maintained which will in turn further improve the treatment efficiency for nutrient removal. The improved selective pressures are expected to result in a mixed liquor microbial communities which settle more rapidly and are more effective at using the influent wastewater carbon to optimize phosphorus and nitrogen removal. The present invention is expected to broaden the opportunities for the development of AGS within new and existing activated sludge processes. The present invention will overcome the limitations of using diffused air alone in the design and control of surface wasting used as a physical selector in AGS activated sludge systems by providing an independent mixing system separate from the diffused air aeration system. The independent mixing system will work in conjunction with a microprocessor based system which controls the time and duration of the surface wasting of mixed liquor over an automated weir. The mixing and surface wasting systems provided by the present invention will allow for maintenance of a wide range of mixing and wasting conditions in the reactor basin as needed to provide the necessary conditions for developing and maintaining AGS mixed liquor activated sludge from start-up of the process up to and including a mature and highly efficient steady-state operation.

A key objective of the present invention is to optimize surface wasting of activated sludge mixed liquor to provide effective physical separation selective pressures, which favor the development and retention of the AGS in an activated sludge process and together with other selective pressures. Achieving this key objective further allows for a transition from a conventional flocculant activated sludge EBPR system at start up to a predominantly AGS system, once the system has reached steady state conditions.

Preferred embodiments of the present invention, which achieve this objective, include treatment process configurations that promote the formation of aerobic granules within the mixed liquor in one or more of the activated sludge compartments. Additionally, wasting of excess activated sludge from the surface of a reactor zone usually is provided for, this wasting step typically but not limited to a final aerated zone or the near an end of an aeration cycle in a batch reactor. Also, a control of the aeration and mixing conditions within the aerated reactor zones and particularly the aerated zone and period of time in which surface wasting of activated sludge is carried out, selecting for an optimal size range of the AGS granules within the aerated reactor zones.

In a further objective the present invention a downward opening automated weir provides for a wasting of excess activated sludge bacteria from a surface of the reactor zone, which selects for the better settling aerobic granules. Again, in a SBR system a cycle of the process functions as the reactor zone.

Additionally, as a still further objective of the present invention, automated control of the downward opening surface wasting weir is provided. A precise depth of flow over the weir can be maintained continuously or intermittently in coordination continuous or intermittent mixing under conditions of variable mixing intensities.

Therefore, the present invention will help to increase the opportunities for employing the benefits of AGS in activated sludge systems by improving the functionality and flexibility of a surface wasting physical selection process. The present invention makes it possible to more consistently and reliably achieve conditions which support the development of AGS with optimally sized granules in continuous flow activated sludge wastewater treatment process designs as well as in SBR systems.

The present invention could be readily implemented in both new and existing treatment facilities and will be applicable to both large and small “activated sludge wastewater treatment systems” (ASWTs) as typical waste water treatment plants, to better achieve or improve “enhanced biological phosphorus removal” (EBPR), and “biological nitrogen removal” (BNR), by improving the settling of the activated sludge, along with increased energy efficiency.

### BRIEF DESCRIPTION OF THE DRAWINGS

Exemplary embodiments of the technology will become more fully apparent from the following descriptions and appended claims, taken in conjunction with the accompanying drawings. Understanding that these drawings depict only exemplary embodiments and are, therefore, not to be considered limiting of the scope of the technology, the exemplary embodiments will be described with additional specificity and detail through use of the accompanying drawings in which:

FIG. 1 is a prior art schematic diagram of a typical and simplified EBPR process;

FIG. 2 is a prior art schematic diagram illustrating the metabolism of “phosphorus accumulating organisms” (PAOs) under anaerobic, and aerobic or “oxic” conditions;

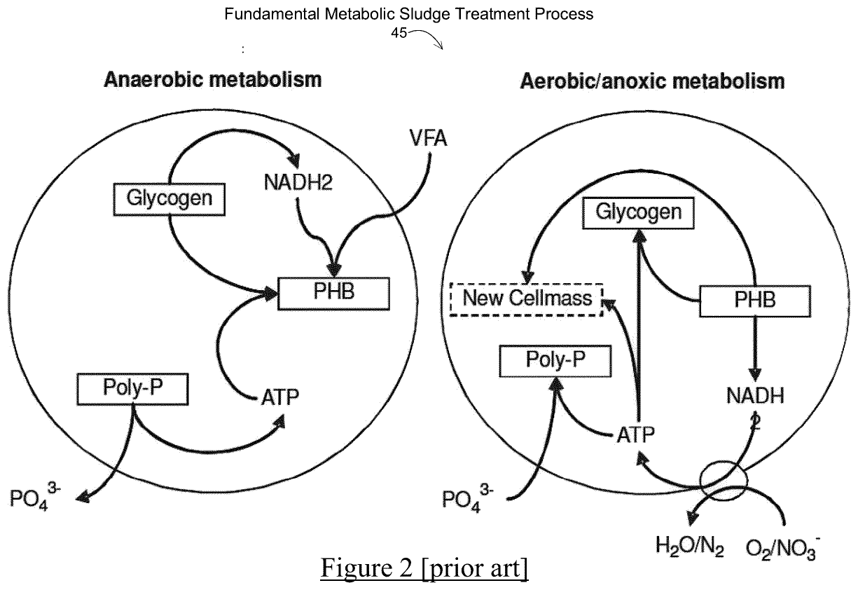

FIG. 3 is a prior art schematic diagram of a typical multi-stage EBPR process;

FIG. 4 is a schematic diagram of a multi-stage EBPR process with an internal recycle flow, in an embodiment of the present invention;

FIG. 5 is a schematic diagram of a multi-stage EBPR process with an internal recycle flow detailing a surface wasting from an aerated zone, in an embodiment of the present invention;

FIG. 6 is a schematic diagram showing a Multi-stage EBPR Process with a fine bubble aeration and a surface wasting, in an embodiment of the present invention;

FIG. 7 is a schematic diagram showing a Multi-stage EBPR Process with a fine bubble aeration and a surface wasting, in an embodiment of the present invention;

FIG. 8 is a schematic logic diagram of a microprocessor controlled mixing regime dependent surface wasting timing and waste volume control system, in an embodiment of the present invention; and

FIG. 9 is a schematic process diagram of an optimization method in an embodiment of the present invention.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and may include fragmentary views, graphic symbols, diagrammatic or schematic representations. Details that are not necessary for an understanding of the present invention by one skilled in the technology of the invention, or render other details difficult to perceive, may have been omitted.

### DETAILED DESCRIPTION OF SPECIFIC EMBODIMENTS

The present invention pertains to a method of a coordinated surface wasting and mixing regime equipment systems together with an associated control logic can that be applied to any activated sludge wastewater treatment process and particularly to “enhanced biological phosphorus removal” (EBPR) treatment process designs, which utilize a compartmented continuous flow activated sludge process.

The present invention can be applied to new and existing activated sludge process configurations, to achieve improved performance in the basic activated sludge process as well as the EBPR and biological nitrogen removal systems, to improve and optimize operational energy efficiency of the system.

A technical description of the present invention is provided herein by way of example. However, it should be noted that other similar configurations and components could be utilized in applying this method including a “sequencing batch reactor” (SBR). Exemplary embodiments of the present invention for operating an activated sludge wastewater treatment system to maximize removal of a nutrient from an activated sludge influent, will be best understood by reference to the drawings included herewith, wherein like parts are designated by like numerals throughout.

In order to design and operate an activated sludge system in which the mixed liquor is predominantly composed of aerobic granules it is necessary to create and maintain conditions which favor the formation of granules and to apply a physical selection process which preferentially retains the optimally sized granules within the system. However, it is also important that the granule size distribution falls predominantly within an optimal size range, which is from approximately 200 to 400 microns in diameter, as suggested by currently available evidence. Granules which are too small will lack the ability to simultaneously nitrify and denitrify, and remove phosphate. Granules which are too large have diffusion limitations and much of the granule will be composed of inactive biomass within its interior portions. While it may not be possible to precisely define an optimal size, it is clear that having the ability to control the size of granule development is very important. One of the effective ways to control granule size is to provide sufficient shear inducing turbulence at one or more points in the activated sludge process. Another method would be to preferentially waste granules which exceed a certain optimal size range.

A primary function of diffused aeration systems in activated sludge aeration basins is the transfer of oxygen to the mixed liquor. In the latter stages of the aeration basins where surface wasting systems are typically applied, the oxygen demand is low and the diffused air flux rates are correspondingly low when controlled to maintain the desire dissolved oxygen concentration in the basin. This generally works well when the primary objectives of surface wasting are to limit filament growth and foam control. It may also work adequately when the objective is to preferentially retain aerobic granules during the start-up phase of a continuous flow activated sludge system. As the activated sludge system's AGS microbial community becomes more fully developed as indicated by particle size distribution analyses and the ability to fully achieve simultaneous nitrification/denitrification in the first aerated zone, then the ability to provide sufficient shear to maintain granule sizes within the optimal range becomes very important as does the ability to waste aerobic granules more uniformly over the entire range of granule sizes in the system. If diffused aeration alone were to be used to provide the necessary shear forces and the degree of mixing necessary to provide uniform wasting over a surface wasting weir, the air flow rate would greatly exceed the rate required to maintain the necessary dissolved oxygen levels. This would be wasteful of energy and could have other adverse impacts to the process such as the return of some oxygen to the anaerobic selector zones in the RAS.

The presence of “phosphorus accumulating organisms” (PAOs) is essential to the development of AGS. The present invention will be particularly well suited when applied to a compartmented plug flow activated sludge EBPR system to enhance the development and maintenance of AGS microbial communities.

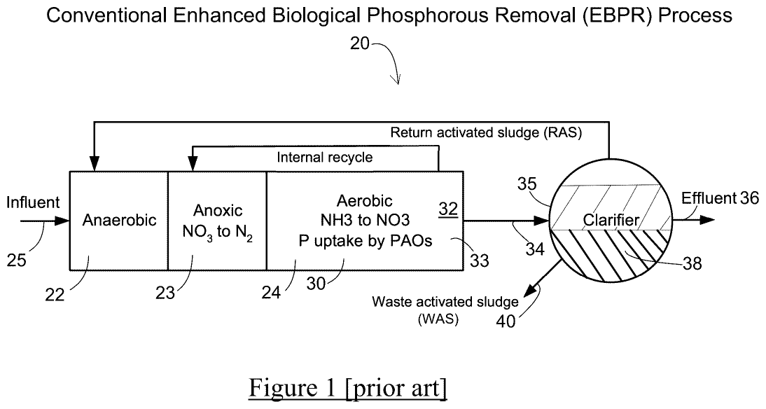

FIG. 1 depicts a simple schematic of a conventional, prior art EBPR system utilizing anaerobic, anoxic, and aerated zones with internal recycle from the aerated zone to the anoxic zone in order to minimize the amount of nitrate returned to the anaerobic zone in the “return activated sludge” (RAS). In most EBPR systems at least a small fraction of the mixed liquor biomass consists of an AGS. The surface wasting method described herein as the present invention will significantly enhance the development of AGS in an EBPR system.

With the incorporation of additional selective pressures into the design and operation such as multi-stage anaerobic selectors and mixed liquor fermentation, the AGS fraction of the biomass can be further enhanced. However, these additional measures are not described herein as elements of the present invention.

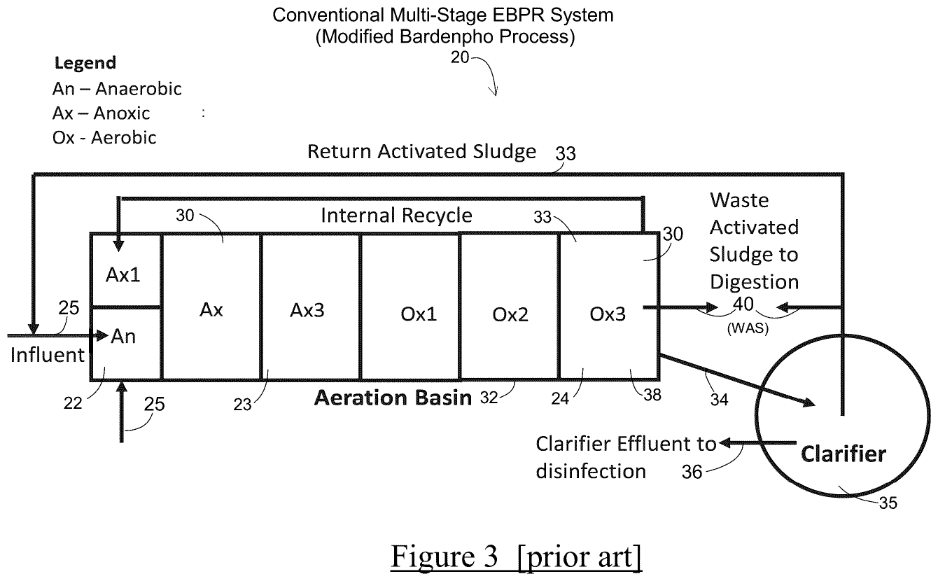

Each zone of the EBPR 20 treatment process as is typical for a wastewater treatment plant 21, as employing “activated sludge wastewater treatment system” (ASWTs), with the waste water treatment plant including an anaerobic zone 22, an anoxic zone 23, and an aerobic zone 24, and can be further compartmented into two or more stages when desired, as shown in the example presented in FIG. 3. The factors which appear to enhance development of the AGS 26 in designs of EBPR wastewater treatment plants include multistage anaerobic and/anoxic selector zones ahead of the aerated zones and physical selection process elements including surface wasting of WAS 40 from an aerated zone, and hydrocyclone separators on the RAS 44, or another internal recycle flow stream.

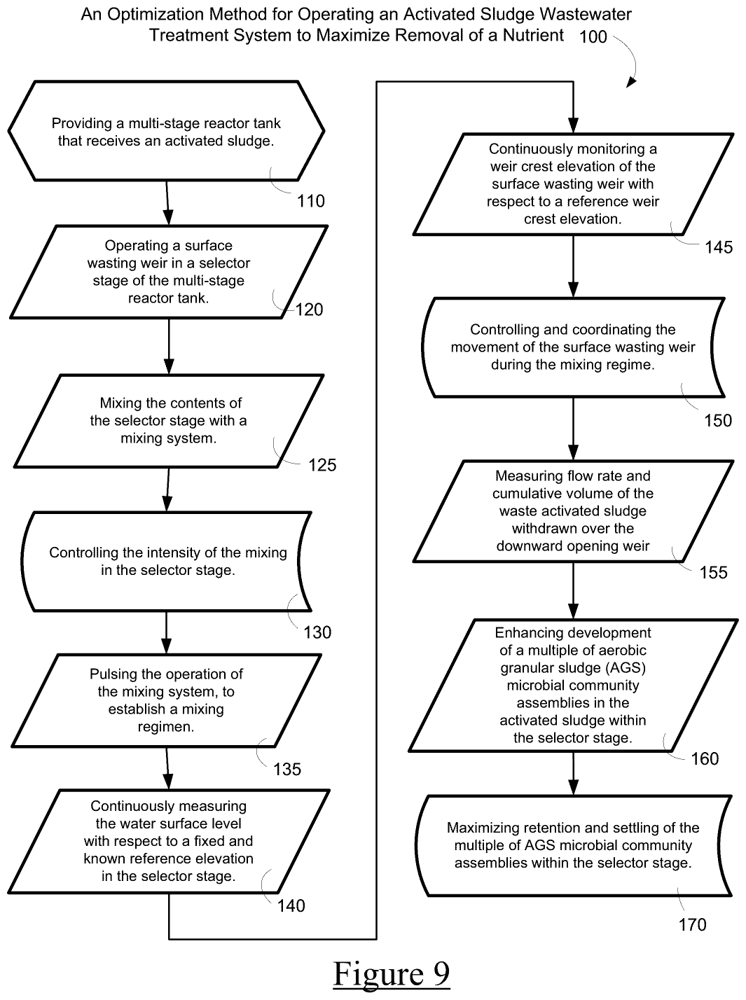

The herein detailed method for operating an activated sludge wastewater treatment system to maximize removal of a nutrient from an activated sludge influent, or more simply referred to herein as the “optimization method of the present invention” 100 that is shown as a schematic logic flowchart in FIG. 9, includes a coordinated surface wasting and mixing regime and the needed equipment and control systems together with the associated control logic. This optimization method can be applied to any activated sludge wastewater treatment process and particularly to EBPR treatment process designs that utilize a compartmented continuous flow activated sludge process. The technical description of the innovation will be provided here by way of example, however, it should be noted that other similar process configurations including SBRs could also be utilized in the application of this method.

As previously introduced, FIG. 1 shows a simple process schematic of a typical EBPR treatment facility that incorporates an anaerobic zone followed by an anoxic zone, and then an aerobic zone that can also be referred to as an “oxic” zone. Each of these zones can be further compartmented into two or more stages, if desired and as shown in the schematic presented in prior art FIG. 3.

Additionally, the presence of PAOs is essential to the development of AGS 26. The present invention will be particularly well suited when applied to a compartmented plug flow activated sludge EBPR system to enhance the development and maintenance of AGS microbial communities.

FIG. 3 depicts a simple schematic of a conventional EBPR system utilizing anaerobic, anoxic, and aerated zones with internal recycle from the aerated zone to the anoxic zone in order to minimize the amount of nitrate returned to the anaerobic zone in the RAS 44. In most EBPR systems at least a small fraction of the mixed liquor biomass consists of aerobic granules. The surface wasting method described herein as the present invention will significantly enhance the development of AGS in an EBPR system.

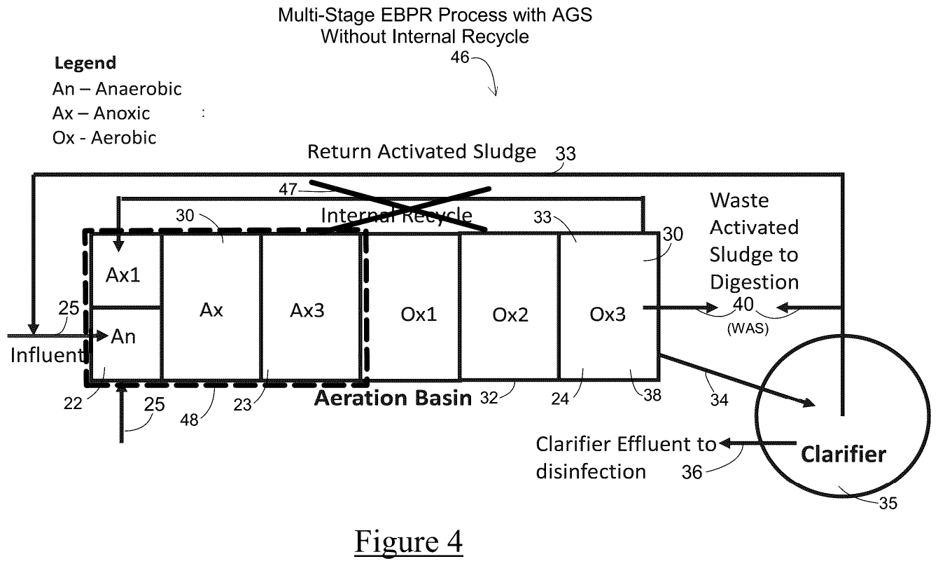

The optimization method of the present invention 100 serves to maximize a removal of a nutrient from an wastewater influent 25 by optimizing selective pressure of a surface wasting weir 55. A primary objective of the optimization method of the present invention is to optimize surface wasting of activated sludge mixed liquor to provide effective physical separation selective pressures which favor the development and retention of the AGS 26 in an activated sludge process and together with other selective pressures to allow for a transition from a conventional flocculant activated sludge EBPR 20 system at start up to a predominantly AGS 26 system once the system has reached steady state conditions. A process flow configuration which is possible once a sufficient fraction of the mixed liquor is composed of aerobic granules is shown in FIG. 4. This objective is achieved with the AGS system running at steady state according to the optimization method of the present invention 100, and with the steps of the invention including operating the EBPR system with one or more anaerobic stages in series followed by one or more aerobic stages where simultaneous nitrification and denitrification occurs within aerobic granular sludge microbial communities. Specifically, when a significant fraction of the activated sludge 33 mixed liquor 30 consists of AGS 26, simultaneous “nitrification and denitrification” (NdN) will occur in the aerated zones 24, and so it is then possible to turn off an internal recycle 47. At this point, all four of the selector zones 48 as shown in FIG. 4 will be anaerobic.

With the incorporation of additional selective pressures into the design and operation such as multi-stage anaerobic selectors and mixed liquor fermentation, the AGS 26 fraction of a biomass can be further enhanced. However, these additional measures are not described herein as elements of the present invention.

In the initial operation of an EBPR system it can be reasonably assumed that the AGS 26 fraction of the mixed liquor biomass will be small. In this case it will be desirable to maximize the physical selection pressure of the surface wasting process in favor of the larger, faster settling AGS particles. To do this, the mixing intensity within the surface wasting reactor zone will be set at the minimum needed to maintain the mixed liquor in suspension. Under these conditions, the AGS particles will be statistically more abundant in the lower portion of the reactor water column and the smaller, lighter flocculant particles will be more abundant in the upper portion of the water column where the mixed liquor flows over the surface wasting weir 55.

If more selective pressure favoring the retention of AGS 26 is needed during start-up or at other times during the operation of the treatment process, the mixing system 60 in the zone from which surface wasting is carried out can be pulsed on and off where the mixing intensity could be at any of the predefined levels as described later herein. In this pulsed mode of operation, the selective pressure can be further increased by moving the surface wasting weir 55 to draw a selected volume of WAS between the mixing pulses. Depending on the intensity and duration of the mixing pulses and the period of time between said pulses, some settling may have begun at the time WAS is withdrawn from the surface of the zone, over the automated surface wasting weir. The mixing pulse interval, pulse duration, mixing intensity, and the associated surface wasting weir control parameters can all be set by the operator in the microprocessor-based control system to occur automatically.

As development of the AGS 26 progresses, following the start-up period it will become necessary to begin increasing the level of mixing intensity which is carried out while surface wasting is taking place. With a higher mixing intensity level, the selective pressure favoring the retention of the larger, faster settling granules will be reduced. The objective during this phase of the operation will be to limit the maximum size of the AGS granules within the mixed liquid with the goal of having a granule size distribution in which granules within the range of 200 to 400 microns are the predominant fraction of the mixed liquor biomass, since granules in this size range provide the most efficient treatment as previously discussed. During this AGS development phase, the mixing intensity level during surface wasting may need to be incrementally increased in order to achieve and maintain the optimal granule size development and size distribution range of approximately 200 to 400 microns.

As the treatment process reaches steady-state conditions where the desired granule size distribution has been achieved, the objective will then be to maintain this size distribution indefinitely. To do this, it may be necessary to completely mix the zone from which surface wasting occurs such that there is no granule size gradient through the depth of the water column in the reactor tank. In the operation of the typical wastewater treatment plant 21, the local conditions of influent flow and loading, temperature and other operating conditions will vary throughout the year. Because of these normal variations, it will be necessary in most cases to make incremental adjustments to periodically increase and decrease the mixing intensity during surface wasting.

Specifically, as shown in the logic flow diagram of FIG. 9, initially, a compartmented reactor tank 50 is provided for the processing of a wastewater influent 25 that is an influent into the wastewater treatment plant 21, with the compartmented reactor tank receiving the wastewater influent 110. The compartmented reactor tank also includes a multiple of selector stages 51. The multiple of selector stages have a minimum of at least one anaerobic stage 22, one anoxic stage 23, and one aerobic stage 24. Alternatively, the optimization method of the present invention 100 can be applied to an SBR system, in which the treatment process steps occur in a single reactor basin in timed cycles rather than in separate compartments. In a SBR system a cycle of the process functions as the reactor zone, so that in the SBR the surface wasting step would most commonly be carried out near the completion of an aerated react cycle.

The optimization method of the present invention 100 operates primarily in a selector stage 52 of the multiple of selector stages 51 within the compartmented reactor tank 50 that also includes the surface wasting weir 55. Operation of the surface wasting weir is automated, the surface wasting weir having a downward opening weir 56 and including a weir crest 57. The surface wasting weir controls a depth of weir flow 58 and a weir flow volume 59 of the activated sludge 33 passing over the weir crest from the selector stage and into a biosolids treatment process stream as the aeration basin effluent 34. The weir crest is defined as a topmost selector stage liquid surface level 76 of the activated sludge 33 passing over the downward opening weir, and the surface wasting weir operates its downward opening weir within one of the selector stages of the multiple of selector stages 120.

The optimization method of the present invention 100 employs a mixing system 60 within of the selector stage 52 of the multiple of selector stages 51 within the compartmented reactor tank 50, which is the selector stage in which the surface wasting weir is also installed. Again, commonly used aeration and mixing systems include surface aerators, and diffused aeration grids that are sometimes coupled with mechanical mixers. The activated sludge 33 is the mixed content of the selector stage in this step in which the surface wasting weir is installed and is mixed with the mixing system 125.

Preferred embodiments for the optimization method of the present invention 100 include the use of an automated downward opening weir, to control depth of flow and volume of the WAS 40 passing over the weir crest to downstream biosolids treatment processes. This surface wasting control weir is described herein as being located in the final aerobic zone of a continuous plug flow reactor as a preferred embodiment of the present invention but could be instead or in addition installed in one or more of the other zones depicted in FIG. 4.

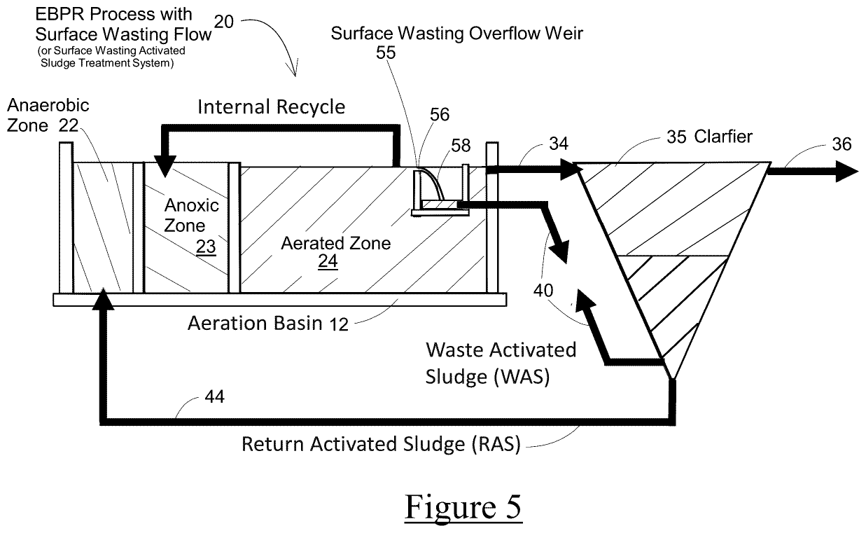

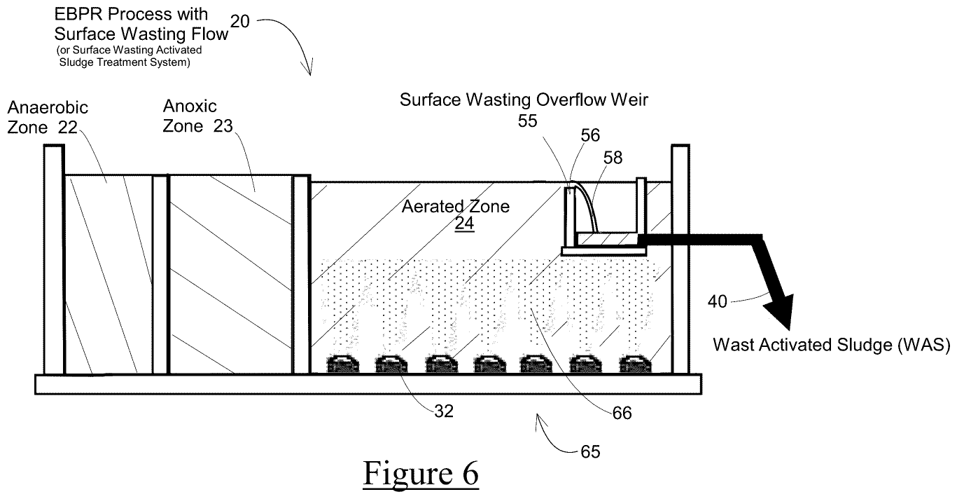

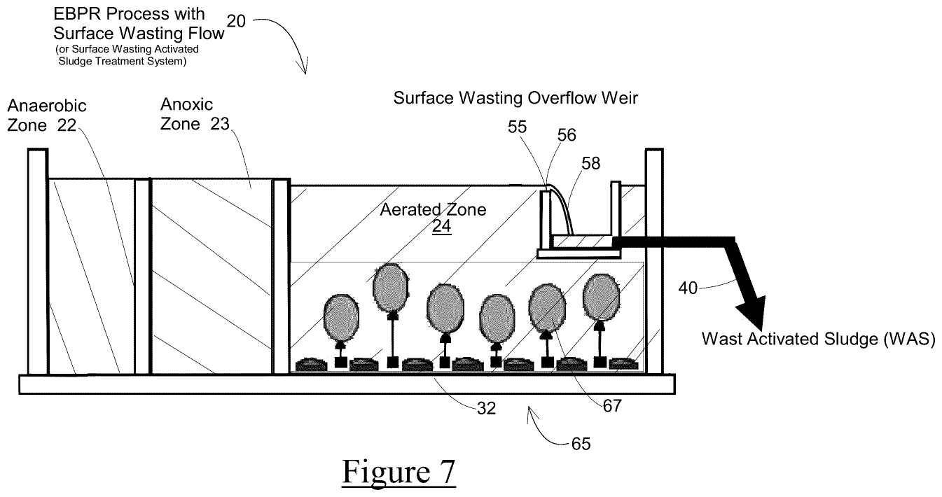

A schematic diagram showing a cross-section of the EBPR process with surface wasting from the aerated or aerobic zone 24 is shown in FIG. 5. The optimization method of the present invention 100 preferably includes a process step of mixing the contents of the reactor zone in which the surface wasting weir is installed, the contents being the activated sludge 33 within the reactor zone or selector stage 52. This step is performed independently of any aeration equipment which may also be installed in that zone. The use of large bubble compressed gas mixing is most preferably employed, but other means of mixing which do not introduce any significant amount of oxygen to the reactor could also be utilized. For instance in an alternative, FIG. 6 shows schematically in cross-section, a multi-stage EBPR process with a fine bubble aeration 66, and surface wasting from the last aerated zone where the diffused fine bubble aeration system 65 provides both oxygen and mixing. Additionally, FIG. 7 is a schematic diagram also showing a cross-section of a multistage EBPR process with surface wasting from the last aerated zone where mixing and fine bubble aeration is provided separately, and shown in FIG. 7 only the mixing is accomplished using the mixing system 60 employing a compressed gas 67.

Surface wasting of activated sludge from an aerated zone is achieved with an aeration system 65, as shown in FIGS. 6 and 7. Aeration systems can employ diffused fine bubble 66 that may be supplemented with the compressed gas 67 for mixing operations. Surface wasting systems originally were developed to control filamentous bacteria and foaming conditions in flocculant activated sludge systems. Surface wasting of activated sludge is a physical selection process employing the fine bubbles introduced by the aeration system tend to lift the filamentous bacteria and foam to the surface of the reactor where they can be removed or wasted from the system by drawing a thin layer of liquid from the surface of the selector stage 52 over the surface wasting weir 55, typically at a weir flow depth 54 of approximately 1 to 2 cm over the downward opening weir 56. Surface wasting in this manner has long been used to effectively control filamentous sludge bulking and foaming in flocculant activated sludge systems. Preferably, the mixing system 60 for the step of mixing the content of the selector stage 125 operates independently of aeration equipment installed in the selector stage. By operating the mixing system independently from of the aeration system provides hydraulic turbulence and shear force, as may be needed to maintain the aerobic granule particle size, again within the optimal size distribution range of approximately 200 to 400 microns.

For the optimization method of the present invention 100, it was found that when such a surface wasting system is applied to an EBPR process able to support the development of some aerobic granules within the microbial population of the activated sludge, it can become a selective process when carefully monitored and controlled. This selective process retains more of the aerobic granules in the system relative to the flocculant bacterial fraction as the mixer liquor is withdrawn from the surface. While the difference in the relative abundance of granules between the upper and lower portions of a selector stage 101 within a compartmented reactor tank 102 may be small, over time the controlled surface wasting of the optimization method of the present invention becomes an important physical selection process, which favors the optimal development of an aerobic granular sludge 68 with a multiple microbial community assemblies 70 selected to be most desirable for effective wastewater treatment, especially in the EPBR process.

The optimization method of the present invention 100, a mixing intensity can be established in the selector stage 52 from which the surface wasting of the activated sludge 33 passing over the weir crest 57. Preferably, at least five (5) or more levels of the mixing intensity are employed. For example, a Level 1 would be the lowest mixing intensity possible using the installed mixing systems and Level 5 would be the highest level of mixing intensity possible using the installed mixing system. Controlling the mixing intensity in the selector stage 130 from which the surface wasting weir is operating, provides the ability to fine tune and optimize the retention and settling of the multiple of microbial community assemblies 70 within the selector stage. Also, it is preferable to install the surface wasting weir and the mixing system in a final aerated zone of the compartmented reactor tank of the multi-compartment plug flow activated sludge reactor.

Pulsing the mixing system 60 on and off in the selector stage 52 of the multiple of selector stages 51 within the compartmented reactor tank 50 from which surface wasting is carried out at any level of the mixing intensity 71 suggested and defined herein above, to establish a mixing regime 72. The optimization method of the present invention therefore includes a step of pulsing the operation of the mixing system within the selector stage 52 in which the surface wasting weir is operating, to establish the mixing regime 135.

In order to develop and maintain a granule size distribution within the optimal range of approximately between 200 to 400 microns, it is necessary to provide sufficient hydraulic turbulence within in the mixed liquor to create the necessary shear force to limit the size of granule development. Providing the appropriate hydraulic shear conditions also tends to produce smoother and more spherical granules. It is not practical to provide sufficient hydraulic shear using fine bubble aeration alone. The air flux rates necessary to provide sufficient shear within the mixed liquor would greatly exceed the air flow rates needed to maintain dissolved oxygen levels within the proper range. Excessively high air flow rates waste energy and can create other adverse process effects such as return of oxygen in the RAS to one or more of the anaerobic selector zones. It is not necessary to provide high hydraulic shear conditions continuously. High intensity mixing can be applied intermittently in one or more zones for short periods of time. The optimum frequency and duration of intermittent high intensity mixing for shear would be determined empirically. The total high intensity mixing duration would typically comprise a relatively small fraction of each 24-hour period. The defined shear mixing instances would normally not overlap or coincide with the surface wasting instances but could overlap or coincide in some cases.

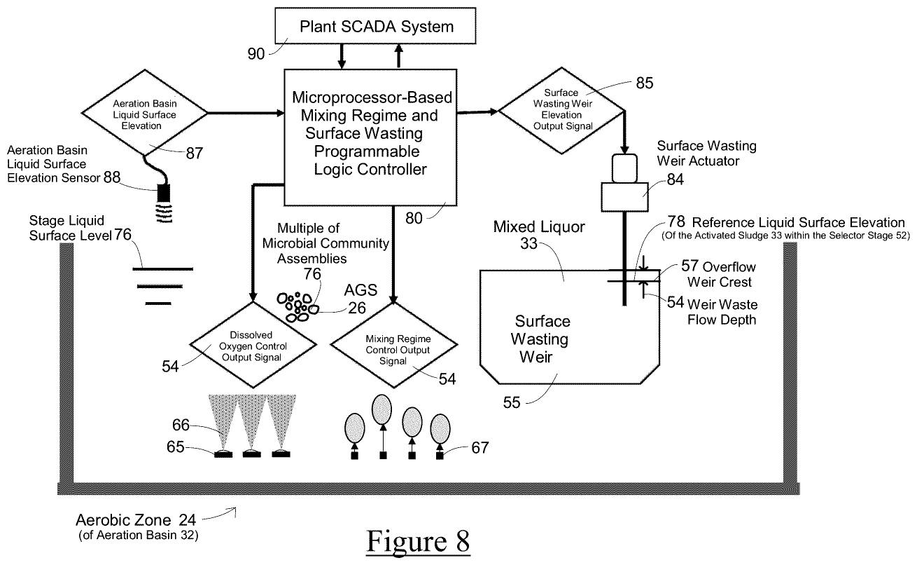

One process variable needed for the optimization method of the present invention 100, is a continuous measurement of a selector stage liquid surface level 76 in the selector stage 52 within the compartmented reactor tank 50. This selector stage liquid surface level is measured with an aeration basin liquid surface elevation sensor 77, as shown schematically in FIG. 8. Importantly, the selector stage liquid surface level is compared to a reference liquid surface elevation 78 within the selector stage, the reference liquid surface elevation being a fixed and known value in each selector stage in which the surface wasting system is installed. By continuously measuring the selector stage liquid surface level with respect to a fixed and known reference elevation in said selector stage 140 in which the surface wasting system weir is operating, the selector stage liquid surface level can be telemetered to a process controller 80, which is most preferably a microprocessor-based mixing regime and surface wasting programmable logic controller.

A second process variable needed for the optimization method of the present invention 100, is a continuous monitoring of a weir crest elevation 82 for the weir crest 57 of the surface wasting weir 55. With a known weir opening elevation 83, the weir flow depth can then be determined. At the typical weir flow depth 54 of approximately 1 to 2 cm over the downward opening weir 56, the weir crest elevation is the same absolute value, approximate 1 to 2 cm, as measured above the weir opening elevation of the downward opening weir. By continuously monitoring the weir crest elevation of the surface wasting weir with respect to the reference weir crest elevation 145, a controlling and coordinating of the movement of the downward opening weir can be performed 150. Most preferably, this control and coordination occurs during the mixing regime 72 and within the selector stage 52. Again, the controlling and coordinating of the movement of the surface wasting weir within the period of a defined mixing regime is most preferably is carried out using the process controller 80, which is most preferably a microprocessor-based mixing regime and surface wasting controller, and receives or is programmed with the input and output values as described herein.

For control strategies implementing the surface wasting weir 55, the optimization method of the present invention 100 includes an automated downward opening weir normally installed in the last aerated aerobic zone 24 or selector stage 52, as the primary means of removing WAS from the system.

As shown in schematic control diagram of FIG. 8, the automated surface wasting weir 55 is controlled to maintain a relatively constant depth over the weir in the range of approximately 1 to 2 cm, by action of a surface wasting weir actuator 84, which controls the weir crest 57 and so the weir flow depth 54 by actuating the downward opening weir 56 whenever surface wasting is initiated. In a preferred embodiment of the present invention, the surface wasting weir actuator will be able to move rapidly and accurately whenever a surface wasting instance is initiated. Whenever surface wasting is not being called for, the weir crest will be raised above the selector stage liquid surface level 76, which is the elevation of the aeration basin's liquid surface. Upon initiation of the surface wasting instance, the surface wasting will be submerged quickly and continuously modulated to maintain the crest over weir setpoint, again in the range of approximately 1 to 2 cm.

A third process variable needed for the optimization method of the present invention 100, is a measurement of a weir flow rate 86 and a cumulative weir volume 87 of the activated sludge 33 topping over the surface wasting weir 55 during a defined period of time. By measuring the weir flow rate and the cumulative weir volume of the activated sludge withdrawn over the downward opening weir 155 of the surface wasting weir, the a weir flow rate and a cumulative weir discharge volume can be telemetered to the process controller 80. These process variables are important for use in enhancing development of a multiple of microbial community assemblies 70 in the waste activated sludge within said selector stage 160, and for maximizing retention and settling of the multiple of microbial community assemblies within said selector stage 170, with note that the activated sludge includes the aerobic granular sludge 68.

Similarly, where surface wasting is carried out in the final aerobic zone of an EBPR system at low diffused aeration flux rates, a selective pressure favoring the retention of larger granules relative to smaller granules, since the larger granules will be relatively more abundant in the lower portions of the selector stage and less abundant in the upper portions of the portions of a selector stage 52 within a compartmented reactor tank 50. These physical selection processes become very important in the development of a continuous flow activated sludge system, which consists predominantly of the aerobic granular sludge 68 and associated multiple of microbial community assemblies 70. This is particularly true during the start-up phase where the system must go through a transition from a flocculent EBPR activated sludge process to an AGS 26 producing process.

As stated above, controlling the operational sequencing and elevation of the automated downward opening weir installed in the selector stage 52 or zone, or in the multiple of selector stages 51 or multiple of zones, where surface wasting is carried out with the programmable microprocessor-based monitoring and control system. Controlling the mixing regime in coordination with the movements of the automated downward opening weir installed in a particular selected selector stage or in the multiple of selector stages where surface wasting is carried out with said programmable microprocessor-based monitoring and control system or microprocessor-based mixing regime and surface wasting controller, and also referred to herein as the process controller 80, or conventionally known as a “programmable logic controller” (PLC). Again, FIG. 8 is a logic diagram of the mixing regime dependent surface wasting timing and waste volume control system, based on microprocessor controller inputs and outputs.

It will be readily understood that the components of the apparatus and process elements employed in the optimization method of the present invention 100, with elements as generally described in this specification and illustrated in the figures herein, could be arranged and designed in a wide variety of different configurations. Thus, the following more detailed description of the embodiments of the apparatus, system, and method is not intended to limit the scope of the present invention, as claimed, but is merely representative of exemplary embodiments of the technology.

The optimization method of the present invention 100 serves to maximize removal of nutrients from an activated sludge mixed liquor by optimizing a surface wasting, to provide a selective pressure of effective physical separation of the activated sludge. The selective pressures favor the development and retention of the AGS 26 in an activated sludge process and together with other selective pressures to allow for a transition from a conventional flocculant activated sludge EBPR system at start up to a predominantly AGS system, once the system has reached steady state conditions.

The dynamic process control methods and strategies to be incorporated into the present invention to optimize the physical selection of the microbial communities within the activated sludge mixed liquor based on particle size and settling velocity using surface wasting. FIG. 8 is a logic diagram of a mixing regime dependent surface wasting timing and waste volume control system based on microprocessor controller inputs and outputs.

In the initial operation of an EBPR 20 system it can be reasonably assumed that the AGS 26 fraction of the mixed liquor biomass 30 will be small. In this case it will be desirable to maximize the physical selection pressure of the surface wasting process in favor of the larger, faster settling AGS particles. To do this, the mixing intensity within the surface wasting reactor zone will be set at the minimum needed to maintain the mixed liquor in suspension. Under these conditions, the AGS particles will be statistically more abundant in the lower portion of the reactor water column and the smaller, lighter flocculant particles will be more abundant in the upper portion of the water column where the mixed liquor flows over the surface wasting weir.

If more selective pressure favoring the retention of AGS 26 is needed during start-up or at other times during the operation of the treatment process, the mixing system in the zone from which surface wasting is carried out can be pulsed on and off where the mixing intensity could be at any of the predefined levels described above. In this pulsed mode of operation, the selective pressure can be further increased by moving the surface wasting weir to draw a selected volume of WAS between the mixing pulses. Depending on the intensity and duration of the mixing pulses and the period of time between said pulses, some settling may have begun at the time WAS 40 is withdrawn from the surface over the automated weir. The mixing pulse interval, pulse duration, mixing intensity, and the associated surface wasting weir control parameters can all be set by the operator in the microprocessor-based control system to occur automatically.

As aerobic granular sludge development progresses following the start-up period, it will become necessary to begin increasing the level of mixing intensity which is carried out while surface wasting is taking place. With a higher mixing intensity level, the selective pressure favoring the retention of the larger, faster settling granules will be reduced. An objective during this phase of the operation will be to limit the maximum size of the AGS 26 within the mixed liquid with the goal of having a granule size distribution in which granules within the range of 200 to 400 microns are the predominant fraction of the mixed liquor biomass, since granules in this size range provide the most efficient treatment as previously discussed. During this AGS development phase, the mixing intensity level during surface wasting may need to be incrementally increased in order to achieve and maintain the optimal granule size development and size distribution range of 200 to 400 microns.

As the treatment process reaches steady-state conditions where the desired granule size distribution has been achieved, the objective will then be to maintain this size distribution indefinitely. To do this, it may be necessary to completely mix the selector stage 52 from which surface wasting occurs such that there is no granule size gradient through the depth of the water column in the reactor tank. In the operation of a typical treatment plant 21, the local conditions of influent flow and loading, temperature and other operating conditions will vary throughout the year. Because of these normal variations, it will be necessary in most cases to make incremental adjustments to periodically increase and decrease the mixing intensity during surface wasting.

In order to develop and maintain a granule size distribution within the optimal range of typically approximately 200 to 400 microns, it is necessary to provide sufficient hydraulic turbulence within in the mixed liquor 30 to create the necessary shear force to limit the size of granule development. Providing the appropriate hydraulic shear conditions also tends to produce smoother and more spherical granules. It is not practical to provide sufficient hydraulic shear using fine bubble aeration alone. The air flux rates necessary to provide sufficient shear within the mixed liquor would greatly exceed the air flow rates needed to maintain dissolved oxygen levels within the proper range. Excessively high air flow rates waste energy and can create other adverse process effects such as return of oxygen in the RAS to one or more of the anaerobic selector zones. It is not necessary to provide high hydraulic shear conditions continuously. High intensity mixing can be applied intermittently in one or more zones for short periods of time. The optimum frequency and duration of intermittent high intensity mixing for shear would be determined empirically. The total high intensity mixing duration would typically comprise a relatively small fraction of each 24-hour period. The defined shear mixing instances would normally not overlap or coincide with the surface wasting instances but could overlap or coincide in some cases.

For the optimization method of the present invention 100, the automated surface wasting weir 55 is controlled to maintain a relatively constant depth over the downward opening weir 56, again in the approximate range of 1 to 2 cm, whenever surface wasting is initiated. In a preferred embodiment of the optimization method of the present invention 100. The process controller 80 serves to monitor and control the action of the surface wasting weir 55, with the optimization method of the present invention 100, precisely controlling the downward opening and upward closing, surface wasting, as shown in FIGS. 6 and 7.

Also for the optimization method of the present invention 100, vital process variables are input, most preferably to the process controller 80, enabling the accurate and precise control of the mixed liquor surface waste 20 skimmed from the aeration basin 12, as shown in FIGS. 6 and 7. These process variables include an aeration surface elevation 54, which must be compared with and correlated to the relative elevation of the overflow weir crest 36. The aeration basin liquid surface elevation, or more simply the “aeration surface elevation” 87 is sensed by an “basin elevation sensor” 88, as shown in FIG. 8. The aeration basin liquid surface level elevation is input to the process controller 80, for use in an elevation control algorithm, as programmed into the process controller. The elevation control algorithm is most preferably a standard type of control algorithm written in a conventional programming code, to direct the logical output instructions of the process controller in the defined execution steps as disclosed herein. The elevation control algorithm is preferably integrated into the process controller.

As shown schematically in FIG. 8, as a preferred embodiment of the optimization method of the present invention 100, the “microprocessor-based mixing regime and surface wasting controller”, also referred to herein simply as the process controller 80, is managed and interfaces with a “plant SCADA system” that is a programmed system of computer based algorithms known as a “Supervisory Control and Data Acquisition” (SCADA), which is employed to monitor and control processes within plant-wide, allowing operators to remotely manage equipment like sensors, valves and pumps, typically through a graphical user interface, giving them oversight of the entire plant operation in real-time. A less preferred, alternative execution of the elevation control algorithm is possible, from a personal or facility computer for example, or from a remote or a ‘cloud based’ processor or server.

In an alternative embodiment of the optimization method of the present invention 100, two or more of the aeration basin elevation sensors 88 may be installed the aeration basin 32, with the sensed aeration surface elevation 76 from each, continually averaged by the process controller 80, to compute the aeration surface elevation for input into the elevation control algorithm, again most preferably as programmed into the process controller.

In another alternative embodiment of the optimization method of the present invention 100, the aeration surface elevation 87 in the aeration basin 32 may be acquired using one or more ultrasonic level transmitters as the aeration basin elevation sensor 88.

In yet another an alternative embodiment of the optimization method of the present invention 100, the aeration surface elevation 54 in the aeration basin 12 may be acquired using one or more radar level transmitters as the aeration basin elevation sensor 88.

In another alternative embodiment of the optimization method of the present invention 100, the weir crest elevation for each surface wasting weir is continually measured using a high-resolution camera and image interpretation software.

As preferably residing in the process controller 80, or any computational element, such as a computer, the process controller provides for both an accurate and a precise control of the depth of surface wasting flow over the surface wasting weir 55, without excessive oscillation of the overflow weir's movement and the resultant excessive oscillation in the depth of wasting flow through the overflow weir.

The optimization method of the present invention 100 will help to optimize the efficiency of an EBPR while at the same time achieving the maximum biological nitrogen removal which can be obtained with the available carbon in the influent wastewater, and the present invention could be readily implemented in both new and existing treatment facilities and will be applicable to both large and small wastewater treatment plants 21.

The optimization method of the present invention 100 will achieve the improved efficiencies by increasing the selective pressures on the microbial communities which make up the activated sludge used for biological nutrient removal to help develop and maintain the AGS 26, and thus increase the relative portion of AGS in the microbial population making up the activated sludge 33 and mixed liquor 30. In addition, the optimal AGS particle size distribution will be maintained which will in turn further improve the treatment efficiency for nutrient removal. The improved selective pressures are expected to result in the mixed liquor with desirable multiple of microbial community assemblies 70, which settle more rapidly and are more effective at using the influent wastewater carbon to optimize phosphorus and nitrogen removal. The present invention is expected to broaden the opportunities for the development of the AGS within new and existing activated sludge processes.

The optimization method of the present invention 100 will overcome the limitations of using diffused air alone in the design and control of surface wasting used as a physical selector in AGS 26 producing systems by providing an independent mixing system separate from the diffused air aeration system. The independent mixing system will work in conjunction with a microprocessor based system which controls the time and duration of the surface wasting of mixed liquor over an automated weir. The mixing and surface wasting systems provided by the present invention will allow for maintenance of a wide range of mixing and wasting conditions in the reactor basin as needed to provide the necessary conditions for developing and maintaining AGS mixed liquor activated sludge from start-up of the process up to and including a mature and highly efficient steady-state operation.

Thus, the optimization method of the present invention 100 will help to increase the opportunities for employing the benefits of AGS 26 in activated sludge systems by improving the functionality and flexibility of a surface wasting physical selection process. The present invention will thus make it possible to more consistently and reliably achieve conditions which support the development of AGS with optimally sized granules in continuous flow activated sludge wastewater treatment process designs as well as the SBR systems.

For this Detailed Description of Specific Embodiments, the terms “connected”, “attached”, “coupled” and “mounted” refer to any form of interaction between two or more elements, including mechanical, electrical, magnetic, electromagnetic, fluid, and thermal interaction. Two components may be functionally coupled with or to each other, even though they are not in direct contact with each other.

Also, the terms “approximately” or “approximate” are employed herein throughout, including this detailed description and the attached claims, with the understanding that is denotes a level of exactitude commensurate with the skill and precision typical for the particular field of endeavor, as applicable.

Additionally, the terminology used in this Detailed Description of Specific Embodiments is to be interpreted according to ordinary and customary usage in the field of the invention as exemplified in the pertinent U.S. and International Patent Classification Codes, and equivalent codes in other patent classification systems.

The word “embodiment” is used herein to mean “serving as an example, instance, or illustration.” Any embodiment described herein is not necessarily to be construed as preferred or advantageous over other embodiments. While the various aspects of the embodiments are presented in drawings, the drawings are not necessarily drawn to scale.

Additionally, reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that the above Detailed Description of Specific Embodiments includes the referenced figures and following claims, and is more simply referred to herein as the “description” or the “disclosure”. In this description, various features are sometimes grouped together in a single embodiment, figure, or written explanation thereof for the purpose of streamlining this disclosure. However, this method of disclosure is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this description are hereby expressly incorporated into this description and disclosure, with each claim standing on its own as a separate embodiment. This description includes all permutations of the independent claims with their dependent claims.

In compliance with the statutes, the invention has been described in language more or less specific as to structural features and process steps where applicable. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

What is claimed is:

1. An optimization method for operating an activated sludge wastewater treatment system to maximize removal of a nutrient from an influent into a wastewater treatment plant, said optimization method comprising the steps of:
a) providing a compartmentalized reactor tank that receives a wastewater, the compartmentalized reactor tank having a multiple of selector stages, the multiple of selector stages including a minimum of an anaerobic stage, an anoxic stage, and an aerobic stage;
b) operating a surface wasting weir in a selector stage of said multiple of selector stages, the surface wasting weir being automated, having a downward opening weir and including a weir crest, and the surface wasting weir controlling a depth of flow and a volume of an activated sludge passing over the weir crest from the selector stage and into a biosolids treatment process stream;
c) mixing a contents of said selector stage in which the surface wasting weir is installed with a mixing system;
d) controlling an intensity of mixing in said selector stage from which the surface wasting weir is operating;
e) pulsing operation of said mixing system in said selector stage in which the surface wasting weir is operating, to establish a mixing regime;
f) continuously measuring a selector stage liquid surface level with respect to a fixed and known reference elevation in said selector stage in which the surface wasting system weir is operating;
g) continuously monitoring a weir crest elevation of said surface wasting weir with respect to a reference weir crest elevation:
h) controlling and coordinating the movement of said downward opening weir of the surface wasting weir during said mixing regime within said selector stage;
i) measuring a flow rate and a cumulative volume of the activated sludge withdrawn over said downward opening weir of the surface wasting weir;
j) enhancing development of a multiple of aerobic granular sludge microbial community assemblies in the activated sludge, within said selector stage by optimizing a selective pressure on the multiple of aerobic granular sludge microbial community assemblies with the surface wasting weir, the activated sludge including an aerobic granular sludge; and
k) maximizing retention and settling of said multiple of aerobic granular sludge microbial community assemblies within said selector stage.

2. The optimization method of claim 1, including the additional step of:
l) mixing within a reactor zone with a large bubble compressed gas stream, said reactor zone in the selector stage of said multiple of selector stages in which the surface wasting is carried out.

3. The optimization method of claim 1, wherein the mixing system for said step of mixing the content of the selector stage operates independently of an aeration equipment installed in said selector stage.

4. The optimization method of claim 3, including the additional step of:
l) mixing within a reactor zone with a large bubble compressed gas stream, said reactor zone in the selector stage of said multiple of selector stages in which the surface wasting is carried out, and said large bubble compressed gas stream operates independently from said aeration equipment installed in said selector stage.

5. The optimization method of claim 1, wherein said step of mixing said content of the selector stage provides said mixing over a range of mixing intensities.

6. The optimization method of claim 1, including the additional step of:
l) installing said surface wasting weir and said mixing system in a final aerated zone of said compartmentalized reactor tank of the multi-compartment plug flow activated sludge reactor.

7. The method of claim 1, wherein a pulsed mixing is performed in any zone of the series of timed treatment cycles during which said surface wasting is carried out, the pulsed mixing using said mixing system that is independent of the aeration system and can be applied over a range of mixing intensities.

8. The method of claim 1, wherein the mixing system independent of the aeration system is operated together with the surface wasting mixing function to provide a hydraulic turbulence and a shear force as may be needed to maintain the aerobic granule particle size within the optimum size distribution range.

9. The method of claim 1, wherein the mixing system independent of the aeration system is operated together with or separately from the surface wasting mixing function to provide hydraulic turbulence and shear force as may be needed to maintain the aerobic granule particle size within the optimum size distribution.

10. The method of claim 1, including the additional steps of:
l) providing a programmable microprocessor-based monitoring and control system (PLC)
m) controlling the operational sequencing and elevation of the automated downward opening weir installed in a zone or in a multiple of zones where surface wasting is carried out with said programmable microprocessor-based monitoring and control system;
n) controlling the mixing regime in coordination with the movements of the automated downward opening weir installed in said zone or in said multiple of zones where surface wasting is carried out with said programmable microprocessor-based monitoring and control system; and
o) controlling the crest over weir of the automated downward opening weir with respect to a fixed and known reference elevation in said zone or in said multiple of zones where surface wasting is carried out with said programmable microprocessor-based monitoring and control system.

11. An optimization method for operating an activated sludge wastewater treatment system to maximize removal of a nutrient from an influent into a wastewater treatment plant, said optimization method comprising the steps of:
a) providing a sequencing batch reactor with a single reactor basin that receives a wastewater, in which a series of timed treatment cycles are employed, the series of timed treatment cycles including a minimum of an anaerobic cycle, an anoxic cycle, or an aerobic cycle;
b) operating a surface wasting weir in a surface wasting step of said series of timed treatment cycles, with the surface wasting weir automated, having a downward opening weir and including a weir crest, and the surface wasting weir controlling a depth of flow and a volume of an activated sludge passing over the weir crest from the single reactor basin and into a biosolids treatment process stream;
c) mixing a contents of said single reactor basin in which the surface wasting weir is installed with a mixing system;
d) controlling an intensity of mixing in said surface wasting step in which the surface wasting weir is operating;
e) pulsing operation of said mixing system in said surface wasting step in which the surface wasting weir is operating, to establish a mixing regime;
f) continuously measuring a reactor basin liquid surface level with respect to a fixed and known reference elevation in said surface wasting step in which the surface wasting system weir is operating;
g) continuously monitoring a weir crest elevation of said surface wasting weir with respect to a reference weir crest elevation:
h) controlling and coordinating the movement of said downward opening weir of the surface wasting weir during said mixing regime within said surface wasting step;
i) measuring a flow rate and a cumulative volume of the activated sludge withdrawn over said downward opening weir of the surface wasting weir;
j) enhancing development of a multiple of aerobic granular sludge microbial community assemblies in the activated sludge, within said selector stage by optimizing a selective pressure on the multiple of aerobic granular sludge microbial community assemblies with the surface wasting weir, the activated sludge including an aerobic granular sludge; and
k) maximizing retention and settling of said multiple of aerobic granular sludge microbial community assemblies within said single reactor basin.

12. The optimization method of claim 11, including the additional step of:
l) mixing within a reactor zone with a large bubble compressed gas stream, said reactor zone in the surface wasting step of said series of timed treatment cycles in which the surface wasting is carried out.

13. The optimization method of claim 11, wherein the mixing system for said step of mixing the content of the surface wasting step occurs independently of an aeration equipment used in said surface wasting step.

14. The optimization method of claim 13, including the additional step of:
l) mixing within a reactor zone with a large bubble compressed gas stream, said reactor zone in the surface wasting step of said series of timed treatment cycles in which the surface wasting is carried out, and said large bubble compressed gas stream occurs independently from said aeration equipment used in said surface wasting step.

15. The optimization method of claim 11, wherein said step of mixing said content of the surface wasting step provides said mixing over a range of mixing intensities.

16. The optimization method of claim 11, including the additional step of:
l) installing said surface wasting weir and said mixing system in a final aerating step of the series of timed treatment cycles in said sequencing batch reactor with a single reactor basin.

17. The method of claim 11, wherein a pulsed mixing is performed in any cycle of the series of timed treatment cycles during which said surface wasting is carried out, the pulsed mixing using said mixing system that is independent of the aeration system and can be applied over a range of mixing intensities.

18. The method of claim 11, wherein the mixing system that is independent of the aeration system is operated together with the surface wasting mixing function to provide a hydraulic turbulence and a shear force as may be needed to maintain the aerobic granule particle size within the optimum size distribution range.

19. The method of claim 11, wherein the mixing system that is independent of the aeration system is operated together with or separately from the surface wasting mixing function to provide hydraulic turbulence and shear force as may be needed to maintain the aerobic granule particle size within the optimum size distribution range.

20. The method of claim 11, including the additional steps of:
l) providing a programmable microprocessor-based monitoring and control system (PLC)
m) controlling the operational sequencing and elevation of the automated downward opening weir installed in a step or in a multiple of steps when surface wasting is carried out with said programmable microprocessor-based monitoring and control system;
n) controlling the mixing regime in coordination with the movements of the automated downward opening weir installed in said step or in said multiple of steps when surface wasting is carried out with said programmable microprocessor-based monitoring and control system; and
o) controlling the crest over weir of the automated downward opening weir with respect to a fixed and known reference elevation in said step or in said multiple of steps where surface wasting is carried out with said programmable microprocessor-based monitoring and control system.
